(19) United States
(12) Patent Application Publication
(10) Pub. No.: US 2024/0028323 A1
(43) Pub. Date: Jan. 25, 2024

(54) SIMULATION OF NODES OF CONTAINER ORCHESTRATION PLATFORMS

(71) Applicant: VMWARE, INC., Palo Alto, CA (US)

(72) Inventors: GURIVI REDDY GOPIREDDY, Bangalore (IN); AAKASH CHANDRASEKARAN, Bangalore (IN); UMAR SHAIKH, Dubai (AE); HEMANT SADANA, Haridwar (IN); VENU GOPALA RAO KOTHA, Bangalore (IN)

(21) Appl. No.: 17/988,778

(22) Filed: Nov. 17, 2022

(30) Foreign Application Priority Data
Jul. 25, 2022 (IN) 202241042532

(51) Int. Cl. G06F 8/65

(52) U.S. Cl. CPC G06F 8/65

(57) ABSTRACT

Systems, methods, devices and non-transitory, computer-readable storage mediums are disclosed for simulating nodes of a container orchestration system. An example method includes: deploying a mock node for taking on a role of actual worker nodes, wherein the mock node is provided with a first set of resources providing a first compute capacity and the mock node includes an interface for interacting with an API server of the container orchestration system; configuring the interface to present to the container orchestration system an available compute capacity of a second compute capacity; registering the mock node as an actual worker node of the cluster with the API server based on the interface of the mock node; causing the container orchestration system to deploy a plurality of application pods to the mock node; and obtaining events generated by the interface in the mock node indicating deployment and running statuses of the application pods.

### RELATED APPLICATIONS

Benefit is claimed under 35 U.S.C. 119(a)-(d) to Foreign Application Serial No. 202241042532 filed in India entitled “SIMULATION OF NODES OF CONTAINER ORCHESTRATION PLATFORMS”, on Jul. 25, 2022, by VMware, Inc., which is herein incorporated in its entirety by reference for all purposes.

### TECHNICAL FIELD

The present disclosure relates to simulation of nodes of container orchestration platforms or systems (e.g., Kubernetes systems).

### BACKGROUND

Network Functions Virtualization (NFV) is an initiative to make the process of networking services virtualized instead of running on proprietary hardware. Many of the network services like firewall, Network Address Translation (NAT), load balancer, etc. are virtualized, and they can run as Virtual Machines on any hardware. Telecommunication (Telco) Cloud Automation (TCA) is an implementation of the NFV Orchestrator (NFVO) and the VNF Manager (VNFM) to automate the process of deploying and configuring Network Functions (NF) and Network Services (NS).

### SUMMARY

Systems, methods, devices, and non-transitory, computer-readable storage media are disclosed for simulation of nodes of container orchestration platforms or systems (e.g., Kubernetes systems), such as Kubernetes (K8S) nodes. According to certain implementations, a mock node is deployed for taking on a role of one or more actual worker nodes of the cluster. The mock node is provided with a first set of resources providing a first compute capacity; and the mock node may include an interface for interacting with an API server of the container orchestration system. The interface is configured to present to the container orchestration system an available compute capacity of a second compute capacity. The second compute capacity is greater than the first compute capacity. The mock node is registered as an actual worker node of the cluster with the API server based on the interface of the mock node. The container orchestration system is caused to deploy a plurality of application pods to the mock nodes. The mock nodes does not instantiate the application pods. Events generated by the interface in the mock node are obtained, and the events indicate deployment and running statuses of the application pods.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

These and other methods described in this disclosure may be implemented at least as methods, systems, devices, and non-transitory, computer-readable storage media. The details of the disclosed implementations are set forth in the accompanying drawings and the description below. Other features, objects, and advantages are apparent from the description, drawings, and claims.

### DESCRIPTION OF DRAWINGS

FIG. 1 depicts an example system that can execute implementations of the present disclosure.

FIG. 2 depicts an example architecture of a Kubernetes cloud system, according to some implementations of this disclosure.

FIG. 3 depicts another example architecture of a Kubernetes cloud system, according to some implementations of this disclosure.

FIG. 4 depicts a flowchart illustrating an example method of simulating the Kubernetes nodes, according to some implementations of this disclosure.

FIG. 5 depicts a flowchart illustrating an example method of deploying a cluster and creating mock nodes.

FIG. 6 depicts a flowchart illustrating another example method of simulating the Kubernetes nodes, according to some implementations of this disclosure.

FIG. 7 is a schematic illustration of an example computing system that can be used to execute implementations of the present disclosure.

The same reference symbol used in various drawings indicates like elements.

### DETAILED DESCRIPTION

In telecommunication (Telco) Environments, scale is a crucial factor. Telco Environments can deal with large consumer bases, and any downtime in the infrastructure can be very expensive. Critical bottlenecks of an application can be found only when the system is being tested or utilized with large numbers of loads. Verifying the limits of an application or the underlying architecture requires a lot of hardware and people resources. With only a minimal set of resources being available during the test phase, it can be difficult to evaluate the application limits from a scale perspective. For example, in an NFV-based architecture/deployment due to the various components involved, these major components may require a high scale limit: (1) the number of Kubernetes Clusters deployed and managed by Telco Cloud Automation (TCA); (2) the number of worker nodes within Kubernetes Clusters deployed and managed by TCA; (3) the number of Kubernetes Clusters deployed and managed by a given TCA-CP (TCA Control Plane); (4) the number of Cloud-Native Network Functions (CNFs) deployed within a given Kubernetes Cluster; (5) the number of CNFs deployed within a given TCA-CP; (6) the number of CNFs deployed within the entire TCA, etc.

For validating the total number of CNFs and Kubernetes Clusters that can be handled by the various components, a large number of hardware resources are required. Each CNF deployment requires a Kubernetes Cluster to be available, and every Kubernetes Cluster requires a varied number of computation and storage resources to deploy the corresponding Kubernetes control-plane and worker nodes.

To verify the scale of an application, the application is loaded with higher numbers of CNFs and Kubernetes Clusters that requires a large number of physical infrastructure resources. In some implementations, each CNF instantiation may require a Kubernetes Cluster including a minimum of three nodes, and each node requires physical computation and storage resources. It becomes expensive in terms of hardware and human resources when more such tests need to be performed. Without hardware, the application performance cannot be validated on high loads.

This disclosure provides systems, methods, devices, and non-transitory, computer-readable storage media for simulation of Kubernetes (K8S) nodes, for example, by mocking the lowest level or layer of an architecture of a Kubernetes cloud system (e.g., a TCA system), i.e., the Kubernetes nodes or worker nodes. The Kubernetes cloud system (e.g., a TCA system) architecture can include a hierarchy of multiple layers including, for example, a management cluster in a top layer, a workload cluster in a middle layer, and one or more Kubernetes nodes (worker nodes) in the bottom layer. An architecture of a Kubernetes cloud system can include additional or different layers, with the worker nodes in the lowest or bottom layer. The described techniques can simulate the lowest layer of TCA by simulating the worker nodes.

In Kubernetes, a workload or application is run by placing containers into one or more application pods (or “Kubernetes pods” or simply “pods”) on a worker node in a Kubernetes workload cluster. An application pod is a basic unit of computing that is created and managed in Kubernetes for running one or more applications or workloads. The application pod can include a group of one or more containers, with shared storage and network resources, and a specification for how to run the containers. An application pod models an application-specific “logical host” and contains one or more application containers which are relatively tightly coupled. Typically, an application pod is running on an actual worker node and running an application pod can consume a certain number of physical or actual computational resources (e.g., memory and CPU resources). In some implementations, mock nodes, which can include Virtual Kubelet (VK) pods, replace the real or actual nodes of a workload cluster. A master node in the workload cluster considers or understands the VK pods as the real or actual nodes. A plurality of application pods can be deployed on each VK pod. The information stored in the VK pods, such as the number of application pods, the state or status of each application pod, etc., is of small size (e.g., several hundred bytes), while the VK pods are configured with large computational resources (e.g., storage resources of 200 GB or 300 GB). Thus, a large number of application pods can be scheduled on the workload cluster based on the VK pods, without actually consuming the large number of computational resources required by the actual nodes.

The implementations described herein can provide various technical advantages. For example, firstly, the described techniques can save hardware costs, because many network function workloads can be simulated on a minimal infrastructure. For example, suppose that deploying one Distributed Unit (DU) Network Function (a component of radio access networks) requires eight GB memory, 16 virtual central processing units (vCPUs) and 50 GB storage. For scaling up to 15000 DUs, the hardware requirement would be 120 terabyte (TB) memory, 240000 vCPUs and 750 TB storage. One example implementation of the described techniques can run each Kubernetes cluster with 10 GB memory, one vCPU and 50 GB storage. For 15000 DUs, 25 clusters are required, and thus the hardware requirement would be 250 GB memory, 25 vCPU, and 1.25 TB storage. Secondly, as the physical hardware requirement drops drastically, the described techniques can save infrastructure cost like power, air-conditioning, maintenance costs, etc. Thirdly, the described techniques require less human effort in setting up and maintaining the hardware. Fourthly, the described techniques can deploy a large number of clusters and validate scale in minutes or hours, compared to days or months required in traditional techniques.

In some implementations, in a Kubernetes cloud environment, mock nodes, which can include Virtual Kubelet (VK) pods, replace the real nodes of the workload cluster. Virtual Kubelet is a Kubernetes implementation that masquerades as a kubelet for the purposes of connecting Kubernetes to other APIs. In some implementations, a mock node's resource requirements are injected into VK pods using a ConfigMap. For example, the value of the resource requirements can be set to a large value, e.g., 200 Gigabytes (GB) or 300 GB, while each VK pod stores information that only occupies a small amount of storage space, e.g., several hundred bytes. Thus, many VK pods can be created and achieve the scale numbers for the application with few physical resources. In some implementations, only one mock node configured with large resources (e.g., 200 GB or 300 GB) is created. In some other implementations, multiple mock nodes can be created.

In some implementations, the described techniques can simulate delays, chaos, or/and failures in a real production environment of a Kubernetes cloud system (e.g., a TCA system) by introducing random delays and failures on the TCA with real production environment data from Kubernetes. For example, the delays, chaos, or/and failures can be populated from the bottom level of the Kubernetes nodes, through the workload cluster, and to the management cluster. Statuses, reactions, and/or results of the levels of the TCA system can be tracked and recorded, and be used to simulate failures and generate chaos in the TCA system.

In some implementations, the described techniques can also be used in other applications, for example, running as a Kubernetes controller within a management cluster and automating the process of creating the VK nodes without user intervention. In some implementations, the described techniques can be used in the TKG-based platforms where the virtual nodes can replace the workload cluster actual nodes by integrating with TKG Cluster API Provider vSphere (CAPV) to create VK nodes. In some implementations, the described techniques can be used in additional or different applications.

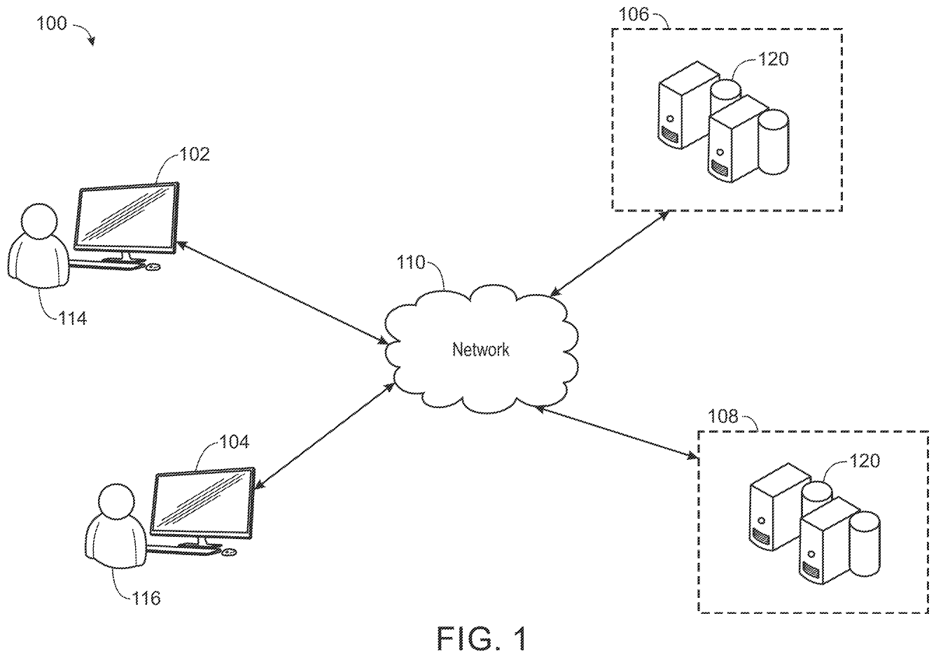

FIG. 1 depicts an example system 100 that can execute implementations of the present disclosure. In the depicted example, the example system 100 includes a client device 102, a client device 104, a network 110, a cloud environment 106, and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smartphone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the cloud environment 106 includes at least one server and at least one data store 120. In the example of FIG. 1, the cloud environment 106 is intended to represent various forms of servers, including but not limited to, a web server, an application server, a proxy server, a network server, and/or a server pool. In general, server systems accept requests for application services and provide such services to any number of client devices (e.g., the client device 102 over the network 110).

In accordance with implementations of the present disclosure, and as noted above, the cloud environment 106 can host applications and databases running on the host infrastructure. In some instances, cloud environment 106 can include multiple nodes that can represent physical or virtual machines (VMs). A hosted application and/or service can run on VMs hosted on cloud infrastructure. In some instances, one application and/or service can run as multiple application instances on multiple corresponding VMs, where each instance is running on a corresponding VM.

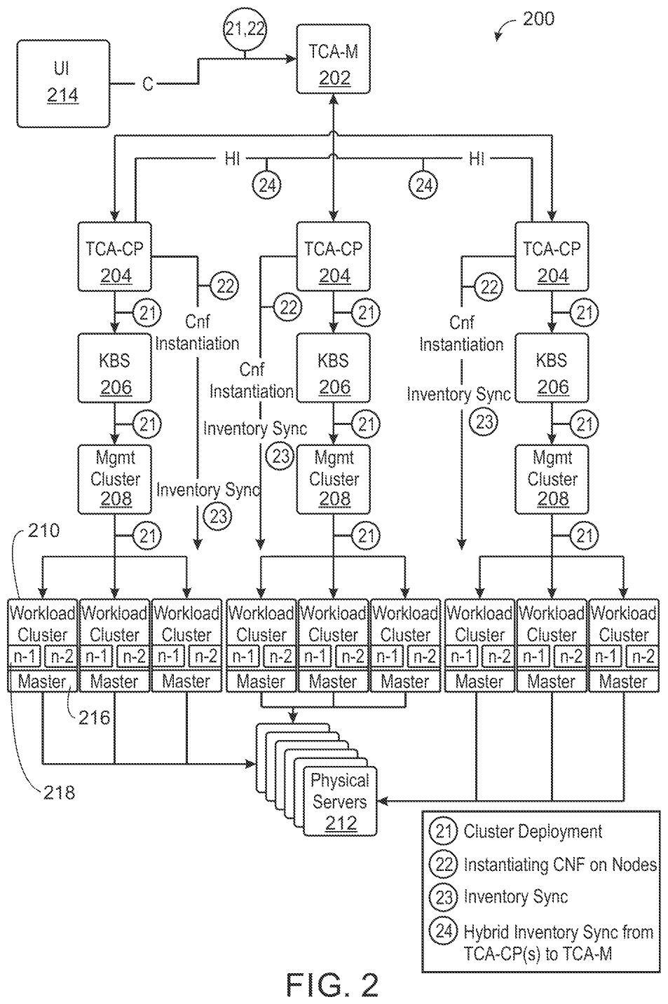

FIG. 2 illustrates an example architecture 200 of a Kubernetes cloud system (e.g., a TCA system). The architecture 200 can be an example architecture of the example system 100 in FIG. 1. The architecture 200 can include TCA Manager (TCA-M) 202, TCA control plane (TCA-CP) 204, Kubernetes Bootstrap (KBS) unit 206, management cluster 208, workload cluster 210, and physical servers 212. A user can send commands (indicated as “C” on FIG. 2) to TCA Manager 202 through User Interface (UI) 214. The commands can be, e.g., cluster deployment (21) or instantiating CNF (22) on nodes. TCA Manager 202 interacts with the UI 214 to orchestrate virtual network functions (VNFs) and automate deployments and configurations of VNFs.

In some implementations, TCA Manager 202 is operating as a combined role of an NFVO and a VNFM. The TCA-CP 204 provides the infrastructure abstraction for placing workloads across clouds using Telco Cloud Automation. The TCA Manager 202 typically manages multiple TCA-CPs 204. TCA Manager 202 combines all the inventories from different TCA-CPs 204 and enables hybrid inventory (a combination of all the inventories from TCA-CPs 204, indicated as “HI” on FIG. 2) synchronization (24) from TCA-CPs 204 to TCA Manager 202. Kubernetes Bootstrap (KBS) unit 206 is configured to bootstrap the management cluster 208. Each TCA-CP 204 is configured to instantiate CNF (22) and synchronize inventory (23).

The management cluster 208 provides resources for the management workload domain. In some implementations, in the Software-Defined Data Center (SDDC), the management cluster 208 is designed to run virtual machines whose primary purpose or role is in providing resources that contribute to managing or monitoring the environment or providing underlying resources for the infrastructure itself.

The workload cluster 210 includes sets of servers that are managed together and participate in workload management. The workload cluster 210 enables enterprise applications to scale beyond the amount of throughput capable of being achieved with a single application server. In some implementations, each workload cluster 210 includes a master node 216 and at least one worker node 218 (n−1, n−2). The master node 216 includes at least one control-plane node. The master node 216 is a node that controls and manages a set of worker nodes 218 (with workloads runtime) and resembles a cluster in Kubernetes. The worker node 218 within the management cluster 208 is used to run containerized applications and handle networking to ensure that traffic between applications across the management cluster 208 and from outside of the management cluster 208 can be properly facilitated.

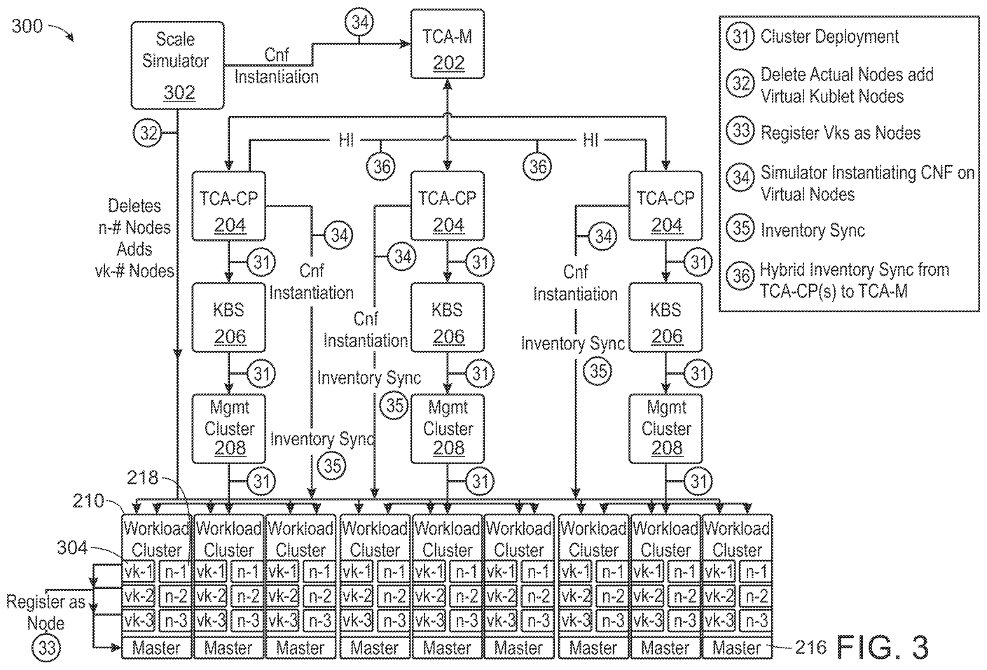

FIG. 3 illustrates another example architecture 300 of a Kubernetes cloud system (e.g., a TCA system). The architecture 300 can be another example architecture of the example system 100 in FIG. 1. The architecture 300 can include TCA Manager (TCA-M) 202, TCA-CP 204, Kubernetes Bootstrap (KBS) unit 206, management cluster 208, workload cluster 210, and scale simulator 302.

In some implementations, TCA Manager 202 can provide orchestration and management services for Telco clouds. The TCA-CP 204 is responsible for multi-VIM/CaaS registration, synchronizes multi-cloud inventories, and collects faults and performance logs from infrastructure to network functions. TCA-CP 204 and TCA Manager 202 work together to provide Telco Cloud Automation services. TCA Manager 202 connects with TCA-CP 204 through site pairing. TCA manager 202 relies on the inventory information captured from TCA-CP 204 to deploy and scale Kubernetes clusters. TCA Manager 202 combines all the inventories from different TCA-CPs 204 and enables hybrid inventory (indicated as “HI” on FIG. 3) synchronization (36) from TCA-CPs 204 to TCA Manager 202. Kubernetes Bootstrap (KBS) unit 206 is configured to bootstrap the management cluster 208. Each TCA-CP 204 is configured to instantiate CNF (34) and synchronize inventory (35).

The architecture 300 of a Kubernetes cloud system can include a hierarchy of multiple layers including, for example, a first layer of a TCA-control plane (CP) 204, a layer of management clusters 208, and a layer of workload clusters 210. The architecture 300 can include additional or different layers, with the VK pods 304 mocking worker nodes in the lowest or bottom layer.

Scale simulator 302 is configured to simulate the scale of applications run in Kubernetes nodes. In some implementations, operations or functions of cluster deployment (31) are the same as or different from the cluster deployment (21) of FIG. 2. The scale simulator 302 deletes actual worker nodes 218 (n−1, n−2, n−3) in the workload cluster 210 to release resources occupied by actual worker nodes 218. The scale simulator 302 then adds mock nodes (shown as VK pods in FIG. 3) 304 (vk−1, vk−2, vk−3) (32) to replace the actual worker nodes 218. Kubernetes API server (not shown in FIG. 3) in the master node 216 registers VK pods 304 as nodes (mock nodes) (33). Upon registration, the master node 216 treats VK pods 304 as actual worker nodes 218, even though the actual worker nodes 218 have been deleted. Each VK pod 304 includes information such as the number of application pods in the workload cluster 210, the state or status of the application pod (running or failed), etc.

After registration, scale simulator 302 sends a command to TCA Manager 202 to instantiate CNF on mock nodes (VK pods) 304 (34). TCA-CP 204 enables synchronization of inventory (35). The inventory includes information stored in each VK pod 304. TCA Manager 202 combines all the inventories from different TCA-CPs 204 and enables hybrid inventory synchronization (36) from TCA-CPs 204 and TCA Manager 202.

In some implementations, an example method of scale simulation the Kubernetes nodes includes the following steps: 1. deploying a cluster; 2. creating mock nodes; 3. registering the mock nodes; 4. instantiating a CNF; 5. simulating a scale of Kubernetes nodes.

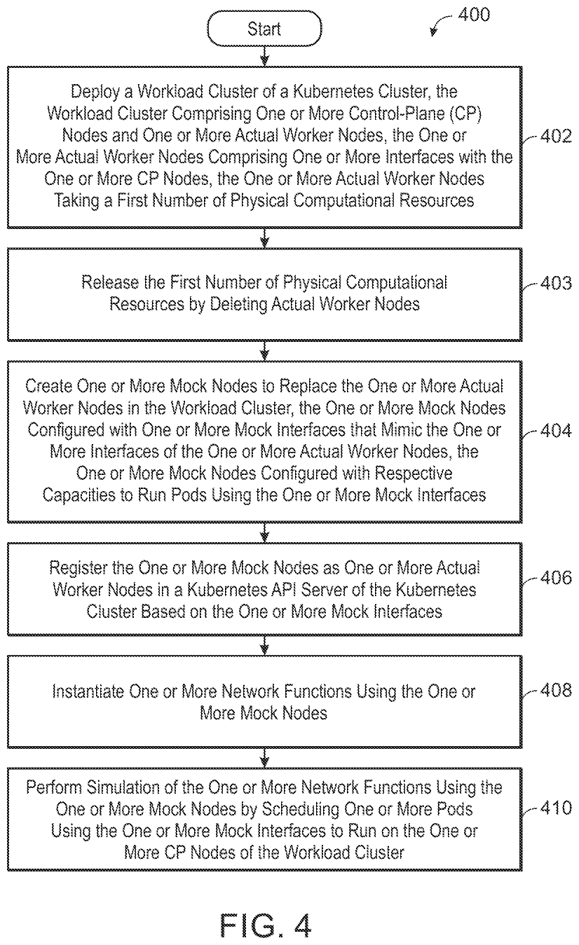

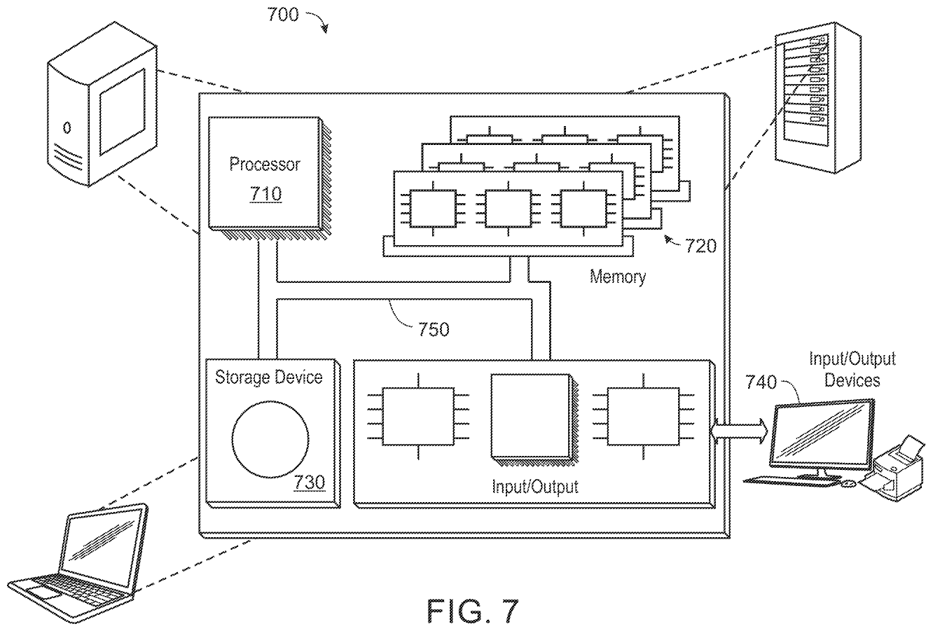

FIG. 4 illustrates a flowchart illustrating an example method 400 of simulating Kubernetes nodes. The example method 400 can be implemented by a data processing apparatus, a computer-implemented system or a computing system such as a computing system 700 as shown in FIG. 7 or the example system 100 with the architecture 200 or 300 as shown in FIGS. 1-3. In some implementations, a computing system can be a system of one or more computers, located in one or more locations, and programmed appropriately in accordance with this disclosure. For example, a computing system 700 in FIG. 7, appropriately programmed, can perform the example method 400. In some implementations, the example method 400 can be implemented on or in conjunction with a Digital Signal Processor (DSP), Field Programmable Gate Array (FPGA), processor, controller, and/or a hardware semiconductor chip, etc.

In some implementations, the example method 400 shown in FIG. 4 can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIG. 4 can be executed as multiple separate operations, or one or more subsets of the operations shown in FIG. 4 can be combined and executed as a single operation.

At block 402, the computing system deploys a workload cluster (e.g., the workload cluster 210 in FIG. 3) of a Kubernetes cluster. The workload cluster includes one or more master nodes (e.g., the master nodes 216 in FIG. 3) and one or more actual worker nodes (e.g., the worker nodes 218 in FIG. 3). The master node (also called a control-plane (CP) node) controls and manages worker nodes. The control plane nodes manage the worker nodes and the application pods in the cluster. The one or more actual worker nodes include one or more interfaces that can communicate with the master node (one or more CP nodes). In some implementations, the interface of the actual worker node can communicate with the master node to schedule application pods. The one or more actual worker nodes can occupy, consume, take or otherwise be provided or allocated with an amount of physical computational resources. For example, each actual worker node may require a certain amount of computational resources (e.g., 80 GB storage, 8 CPUs and 16 GB memory) to carry out its function.

In some implementations, the one or more interfaces can include a Container Runtime Interface (CRI). The CRI is a plugin interface which enables the kubelet to use a wide variety of container runtimes, without having a need to recompile the cluster components. A working container runtime is required on each worker node in the workload cluster, so that the kubelet can launch application pods and their containers. The CRI is the main protocol for the communication between the kubelet and Container Runtime. The Kubernetes Container Runtime Interface (CRI) defines the main gRPC (gRPC remote procedure call) protocol for the communication between the cluster components kubelet and container runtime.

In some implementations, a user can create a management cluster (e.g., management cluster 208 in FIG. 2 or 3) through a user interface (e.g., user interface 214 in FIG. 2) and a TCA Manager (e.g., TCA Manager 202 in FIG. 2 or 3). The management cluster can be, for example, a Management Kubernetes Cluster. The management cluster is a Kubernetes cluster that runs cluster API operations on a cloud to create and manage Workload Clusters on that cloud. The management cluster lives in the management workload domain and runs the virtual machines. These virtual machines can host one or more management and controller applications such as virtual infrastructure managers and/or controllers, hosts, network orchestrators and controllers, system and network monitoring, etc. In some implementations, the management cluster includes a certain number of control-plane nodes and worker nodes. For example, the management cluster includes three control-plane nodes (master nodes) and two worker nodes. In some implementations, each control-plane node and worker node in the management cluster may be required to have certain number of resources. For example, each control-plane node in the management cluster requires, e.g., 50 GB storage, 8 CPUs, and 16 GB memory, whereas each worker node in the management cluster requires, e.g., 80 GB storage, eight CPUs, and 16 GB memory.

In some implementations, once the management cluster is deployed, a workload cluster (e.g., the workload cluster 210 in FIG. 3) can be deployed. The shared and in-cluster services that the workload clusters use are also configured in the management cluster. In some implementations, a workload cluster requires a certain number of control-plane nodes and worker nodes. For example, a workload cluster may require three control-plane nodes and two worker nodes. In some implementations, each control-plane node and worker node in the workload cluster may be assigned with a certain minimum amount of resources, which can be the same as or different from the resources required by the management cluster. For example, each control-plane node in the workload cluster may require, e.g., 50 GB storage, 8 CPUs, and 16 GB memory, whereas each worker node in the workload cluster requires, e.g., 80 GB storage, eight CPUs, and 16 GB memory. These worker nodes are actual worker nodes.

At block 403, the computing system releases the first number of physical computational resources by deleting the actual worker nodes. In some implementations, the computing system deletes actual worker nodes (e.g., shown as workload nodes 218 in FIG. 3) in the workload cluster to release resources occupied by actual worker nodes. In some implementations, the computing system deletes the actual worker nodes by deleting a configuration object (e.g., a MachineDeployment custom resource (CR)) for a namespace of the workload cluster. In some implementations, a CR represents a customization of a particular Kubernetes installation. A CR can be an extension of the Kubernetes API or another configuration file or object. A MachineDeployment CR can be used to specify one or more machine objects (e.g., actual worker nodes and/or related resources) deployed for a particular Kubernetes installation. By deleting the MachineDeployment CR object, the one or more machine objects (e.g., actual worker nodes and/or related resources) can be deleted automatically.

At block 404, the computing system creates one or more mock nodes (e.g., shown as VK pods 304 in FIG. 3) to replace the one or more actual worker nodes in the workload cluster. The one or more mock nodes are configured with one or more mock interfaces that mimic the one or more interfaces of the one or more actual worker nodes. The one or more mock nodes are configured with respective capacities to run application pods using one or more mock interfaces. The VK pods (e.g., VK pods 304 in FIG. 3) using the one or more mock interfaces are mock nodes. For example, a kubelet in an actual worker node provides one or more interfaces for managing a life cycle of an application pod (e.g., PodLifeCycleManagement) and managing a life cycle of an actual worker node (e.g., NodeLifeCycleManagement). In some implementations, the one or more interfaces of the one or more actual worker nodes can include one or more interfaces implemented to handle creating an application pod having a (data storage) volume, updating the application pod, deleting the application pod, obtaining the application pod, obtaining a status of the application pod, obtaining a plurality of application pods, notifying the plurality of application pods, or any other methods. Similarly, a virtual kubelet (VK) in a mock node is configured with one or more mock interfaces that mimic the one or more interfaces implemented to handle Create, Delete, Update and Get Status methods of a kubelet in an actual worker node. The one or more mock nodes consume or occupy less physical computational resources (less memory and storage and fewer vCPUs) than those of actual worker nodes.

Each mock node provides one or more mock interfaces that mimic one or more interfaces of an actual worker node, which allows the master node to interact with a mock node as if it were an actual worker node. For example, the one or more mock interfaces can include pod Life Cycle Interfaces, such as CreatePod, UpdatePod, DeletePod, GetPod, GetPodStatus, GetPods, and NotifyPods for creating an application pod, updating an application pod, deleting an application pod, obtaining a particular application pod, obtaining a status of an application pod, obtaining a plurality of application pods, and notifying a plurality of application pods, respectively. In some implementations, the one or more mock interfaces can also include additional or different pod Life Cycle interfaces.

In some implementations, each mock node is deployed with 256 megabytes (MB) of memory and 1 CPU for the corresponding worker node, and each mock node is labeled as a VK pod. These VK pods are marked to be deployed only on control-plane nodes (master nodes) of the workload cluster, but do not run on the actual worker nodes.

At block 406, the computing system (e.g., the master node 216 in FIG. 3 of a computing system or a Kubernetes API server) registers the one or more mock nodes as one or more actual worker nodes in the Kubernetes API server of the Kubernetes cluster based on the one or more mock interfaces. The master node considers the one or more mock nodes as one or more actual worker nodes and schedules workloads using VK pods of the one or more mock nodes based on capacities of the one or more mock nodes.

The capacities of the one or more mock nodes (e.g., the computational resource such as the number of CPUs and the size of memory, which decides the number of application pods that can run on a mock node) can be configurable (e.g., by a user (operator)). In some implementations, to support scale simulation, the one or more mock nodes can be configured to take on a role of actual nodes. The one or more mock nodes can be configured with much larger capacities (e.g., 200 or 300 GB) than the capacities available to the one or more actual nodes (e.g., 80 GB). Accordingly, more application pods are allowed to be scheduled on the one or more mock nodes than the application pods that can be scheduled on the one or more actual worker nodes. In some implementations, resource configurations are injected, written, or otherwise configured into a VK pod as a configuration object (e.g., ConfigMap object). Setting the value of resource requirements to a large value (e.g., 200 GB or 300 GB) helps to schedule as many application pods as possible on a mock node. In some implementations, a mock node contains an in-memory cache which is then updated for storing the application pod object information (e.g., the ConfigMap object). In some implementations, the ConfigMap object is stored on the CP nodes. Marking states of all these application pods to “Running”/“Failed” state helps to propagate this state information back to the Kubernetes Inventory service within TCA. In some implementations, delays or chaos can be generated in the TCA system, for example, by configuring the capacities of the one or more mock nodes. As any resource change on Kubernetes objects can be automatically synchronized to TCA, a change in the state or status of the application pod will also simulate a real-life load on TCA systems. The state information can be used, for example, to determine the limits of the TCA for scale simulations.

At block 408, the computing system instantiates one or more network functions (e.g., CNFs) using the one or more mock nodes. Once the Kubernetes cluster is ready with the VK pods, the user can instantiate a CNF, for example, using the Cloud Service Archive (CSAR) from TCA Manager. The TCA Manager can parse the CSAR and then instantiate helm charts on the nodes that are mocked. Because mock nodes (i.e., VK pods) can be configured with a very large number of resources (e.g., 200 GB or 300 GB), many CNFs can be instantiated on the same cluster.

In a TCA system, the major interaction with VMs and CNFs is identified to be via the Inventory modules. TCA services continuously synchronize the latest metadata of the Kubernetes objects and report alarms to the dashboard for failures. To validate scale on such a TCA system, instead of just loading the database with simulated data, a more dynamic and real-time simulator can be provided.

At block 410, the computing system performs simulation (e.g., scale simulation) of the one or more network functions using the one or more mock nodes. In some implementations, the master node schedules one or more application pods using the one or more mock interfaces (i.e., VK pods) to run the workloads in the simulation. The simulation can determine one or more limits of: the number of Kubernetes clusters deployed and managed by the TCA platform, the number of worker nodes within Kubernetes clusters deployed and managed by the TCA platform, the number of Kubernetes clusters deployed and managed by a given the TCA-CP, the number of network functions deployed within a given Kubernetes cluster, a number of network functions deployed within a given TCA-CP, or the number of network functions deployed within the TCA platform.

In some implementations, a VK pod can be configured with a volume, for example, using a CreatePod interface that mimics the actual interface for creating an application pod. The CreatePod interface can configure a volume of an application pod when creating the application pod. A volume includes a directory that contains data accessible to containers in a given application pod in the orchestration and scheduling platform (e.g., the Kubernetes system). Volumes provide a plugin mechanism to connect ephemeral containers with persistent data stores elsewhere. The described VK-based techniques enable managing various types of application pods by customizing the one or more mock nodes (e.g., writing the configuration information using a configuration object (e.g., ConfigMap) and storing the configuration object in the CP node) as needed based on specific implementations of a service provider of the computing system. In some implementations, the described VK-based techniques do not need to mock container runtime manager, volume manager, or other types of a manager of an application pod individually.

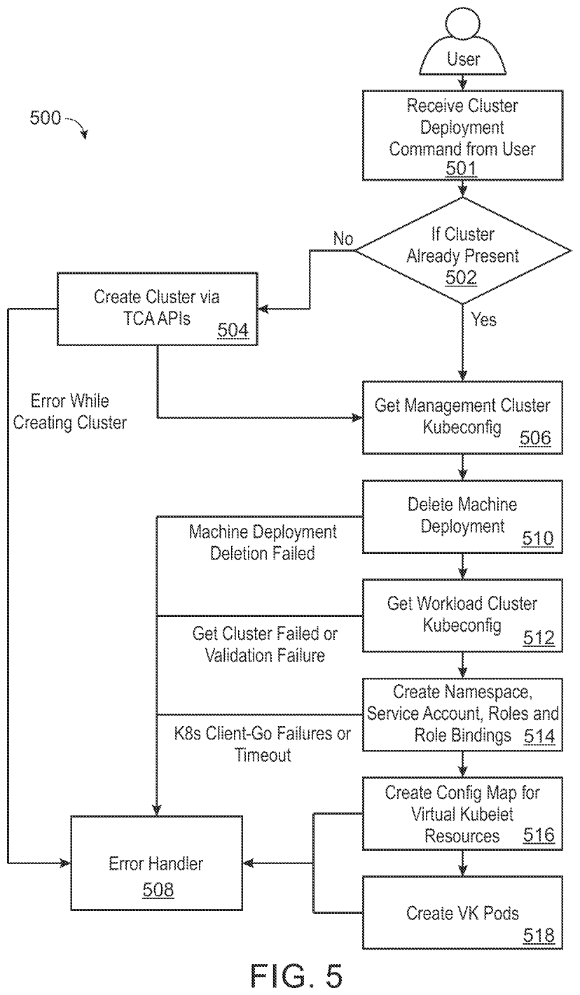

FIG. 5 illustrates a flowchart illustrating an example method 500 of deploying a cluster and creating mock nodes (VK pods). The cluster can be a Kubernetes cluster that includes at least one management cluster and at least one workload cluster. The example method 500 can be an example implementation of block 402 and block 404 of FIG. 4 by a data processing apparatus, a computer-implemented system, or a computing system such as a computing system 700 as shown in FIG. 7 or the example system 100 with the architecture 200 or 300 as shown in FIGS. 1-3. In some implementations, a computing system can be a system of one or more computers, located in one or more locations, and programmed appropriately in accordance with this disclosure. For example, a computing system 700 in FIG. 7, appropriately programmed, can perform the example process 500. In some implementations, the example method 500 can be implemented on Digital Signal Processor (DSP), Field Programmable Gate Array (FPGA), processor, controller, or a hardware semiconductor chip, etc.

In some implementations, the example process 500 shown in FIG. 5 can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIG. 5 can be executed as multiple separate operations, or one or more subsets of the operations shown in FIG. 5 can be combined and executed as a single operation.

At block 501, a computing system receives a cluster deployment command from a user (e.g., an operator or an administrator). At block 502, the computing system decides if a cluster is already present, for example, using scripts operating on the computing system via TCA APIs. If there is no cluster, at block 504, the computing system creates a cluster via TCA APIs, for example, by creating a management cluster on vCenter and a workload cluster within the management cluster. The workload cluster includes one or more actual worker nodes. If there is a cluster, at block 506, the computing system gets or obtains configuration information of the management cluster, for example, from Management Cluster Kubconfig. If there is an error generated during cluster creation, the error will be sent to and handled by an error handler 508.

At block 510, the computing system can delete a configuration object (e.g., MachineDeployment CR) from the management cluster to delete or hide the actual worker nodes. If configuration object deletion fails, the error will be sent to and handled by the error handler 508.

At block 512, the computing system gets or obtains configuration information of the workload cluster within the management cluster, for example, from WorkloadCluster Kubeconfig. If obtaining the configuration information of the workload cluster (e.g., by executing GetWorkloadCluster) fails or validation fails, the error will be sent to and handled by the error handler 508.

At block 514, the computing system creates Namespace, Service Account, Roles, and RoleBindings based on the configuration information of the workload cluster. A Role sets permissions within a particular namespace while a ClusterRole is a non-namespaced resource. A Binding grants permissions defined in a Role or ClusterRole to a user or set of users. A RoleBinding grants permissions to a role in its namespace, while a ClusterRoleBinding grants cluster-wide access.

At block 516, the computing system creates a ConfigMap object for VK resources of one or more mock nodes, for example, to configure the capacities of the one or more mock nodes. A ConfigMap is an API object that allows storing data as key-value pairs. Kubernetes pods can use ConfigMaps as configuration files, environment variables, or command-line arguments. ConfigMaps allow decoupling environment-specific configurations from containers to make applications portable. By using the ConfigMap object for VK resources of one or more mock nodes, the one or more mock nodes can be created to replace the one or more actual worker nodes in the workload cluster.

At block 518, the computing system creates VK pods based on created ConfigMap object, Namespace, Service Account, Roles, and RoleBindings. For example, creating one or more mock nodes can include configuring the one or more mock nodes with one or more mock interfaces that mimic the one or more interfaces of the one or more actual worker nodes.

Blocks 514, 516, and 518 illustrate an example process of creating VK pods. If there are any failures or timeouts (e.g., Kubernetes client-go failures or timeout) during the process, the error will be sent to and handled by the error handler 508.

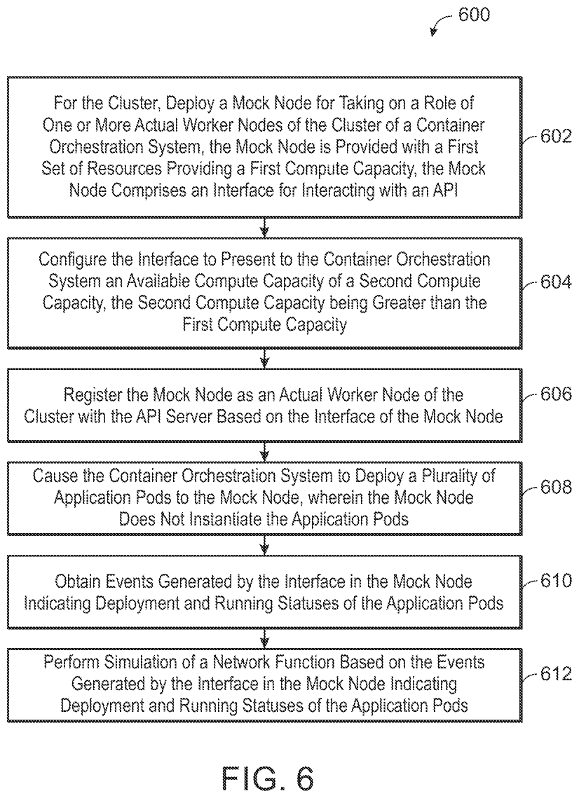

FIG. 6 illustrates a flowchart illustrating another example method 600 of simulating the Kubernetes nodes. The example method 600 can be implemented by a data processing apparatus, a computer-implemented system or a computing system such as a computing system 700 as shown in FIG. 7 or the example system 100 with the architecture 200 or 300 as shown in FIGS. 1-3. In some implementations, a computing system can be a system of one or more computers, located in one or more locations, and programmed appropriately in accordance with this disclosure. For example, a computing system 700 in FIG. 7, appropriately programmed, can perform the example method 600. In some implementations, the example method 600 can be implemented on or in conjunction with a Digital Signal Processor (DSP), Field Programmable Gate Array (FPGA), processor, controller, and/or a hardware semiconductor chip, etc.

In some implementations, the example method 600 shown in FIG. 6 can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIG. 6 can be executed as multiple separate operations, or one or more subsets of the operations shown in FIG. 6 can be combined and executed as a single operation.

At block 602, the computing system deploys a mock node (e.g., VK pod 304 of FIG. 3) for taking on the role of one or more actual worker nodes (e.g., worker nodes 218 of FIG. 2 or 3) of a cluster of a container orchestration system (e.g., a Kubernetes cluster). The mock node is provided with a first set of resources (e.g., very minimal CPU and memory resource) providing a first compute capacity (e.g., several hundred bytes). The mock node includes an interface (e.g., a mock interface) for interacting with an API server of the container orchestration system (e.g., Kubernetes API server).

The mock node is configured to replace actual worker nodes and take on the role of the replaced actual worker nodes. Each mock node, i.e., VK pod, stores information that only occupies a small amount of storage space, e.g., several hundred bytes. In some implementations, the mock node includes an in-memory cache for storing application pod object information (e.g., configuration information, and deployment and running statuses of the application pods).

In some implementations, the block 602 can be implemented according to example techniques described with respect to blocks 402-404 of FIG. 4. For example, the computing system can deploy the cluster of the container orchestration system with the one or more actual worker nodes. After deploying the mock node to take on the role of the one or more actual worker nodes, the computing system can release the third set of resources by deleting the one or more actual worker nodes. Deleting the one or more actual worker nodes includes deleting a configuration object for a namespace of the cluster of the container orchestration system. In some implementations, deploying the mock node includes creating one or more mock nodes by specifying respective capacities of the one or more mock nodes in a configuration object; and storing the configuration object on one or more control-plane (CP) nodes of the cluster of the container orchestration system.

At block 604, the computing system configures the interface (e.g., the mock interface) of the mock node to present to the container orchestration system (e.g., a Kubernetes system) an available compute capacity of a second compute capacity (e.g., 200 GB or 300 GB). The second compute capacity (e.g., 200 GB or 300 GB) is greater than the first compute capacity (e.g., several hundred bytes). The second compute capacity can be an “advertised” or “alleged” compute capacity. The interface is configured to let the Kubernetes cluster deem that the mock node has a large compute capacity (e.g., 200 GB or 300 GB), which the first set of resources provided to the mock node do not actually support. For example, the mock node may only have a capacity of several hundred bytes supported by the first set of resources, but the interface can let the Kubernetes cluster deem that the mock node has a capacity of 300 GB. In some implementations, the second compute capacity is larger than a third compute capacity (e.g., 80 GB) of one or more actual worker nodes that are provided with a third set of resources. In some implementations, the computing system configures the interface of the mock node, for example, by writing the “advertised” or “alleged” second compute capacity in a configuration file, metadata, or other data objects, to present to the container orchestration system the “advertised” or “alleged” second compute capacity of the mock node.

At block 606, the computing system registers the mock node (e.g., VK pod 304 of FIG. 3) as an actual worker node (e.g., worker nodes 218 of FIG. 2 or 3) of the cluster (e.g., Kubernetes cluster) with the API server (e.g., the Kubernetes API server) based on the interface (e.g., the mock interface) of the mock node. In some implementations, the block 606 can be implemented according to example techniques described with respect to the block 406 of FIG. 4. For example, the interface for interacting with the API server includes one or more interfaces for creating an application pod having a volume, updating the application pod, deleting the application pod, obtaining the application pod, obtaining a status of the application pod, obtaining a plurality of application pods, or notifying the plurality of application pods.

At block 608, the computing system causes the container orchestration system (e.g., a Kubernetes system) to deploy a plurality of application pods to the mock node (e.g., VK pod 304 of FIG. 3), and the mock node does not instantiate the application pods. A large number of application pods can be scheduled and deployed on the mock node, but the application pods are not instantiated and executed on the mock node. Only the information related to the deployed application pods, such as the number of application pods, the state or status of each application pod, etc., is stored in the mock node. This type of information only occupies a small size of storage (e.g., several hundred bytes). As depicted at block 604, the interface can let the Kubernetes cluster deem that the mock node has a large compute capacity (e.g., 200 GB or 300 GB). The Kubernetes cluster will thus schedule and deploy a large number of application pods on the mock node with the understanding that the mock node has a large enough capacity to deploy the application pods. In some implementations, causing the container orchestration system to deploy the plurality of application pods includes causing the container orchestration system to deploy the plurality of application pods having volumes using the interface.

At block 610, the computing system subscribes, receives, monitors, or otherwise obtains events generated by the interface in the mock node (e.g., VK pod 304 of FIG. 3) indicating deployment and running statuses of the application pods. The events can be life-cycle events of the application pods. Note that the application pods do not actually run, but the statuses of the application pods are provided, for example, based on the life-cycle events.

At block 612, the computing system performs a simulation of a network function based on the events generated by the interface in the mock node indicating deployment and running statuses of the application pods. One or more network functions can be simulated based on the deployment and running statuses of the application pods. As an example, the block 612 can be implemented according to example techniques described with respect to the block 410 of FIG. 4.

FIG. 7 illustrates a schematic diagram of an example computing system 700. The computing system 700 can be used for the operations described in association with the implementations described herein. For example, the computing system 700 may be included in any or all of the server components discussed herein. The computing system 700 includes a processor 710, a memory 720, a storage device 730, and an input/output device 740. The components 710, 720, 730, and 740 are interconnected using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 720 is a volatile memory unit. In some implementations, the memory 720 is a non-volatile memory unit. The storage device 730 is capable of providing mass storage for the system 700. In some implementations, the storage device 730 is a computer-readable medium. In some implementations, the storage device 730 may be a floppy disk device, a hard disk device, an optical disk device, or a tape device. The input/output device 740 provides input/output operations for the system 700. In some implementations, the input/output device 740 includes a keyboard and/or pointing device. In some implementations, the input/output device 740 includes a display unit for displaying graphical user interfaces.

Some aspects of this disclosure describe a computer-implemented method for simulation a cluster of a container orchestration system (e.g., Kubernetes nodes in a Kubernetes cluster). In some implementations, an example method includes: deploying a workload cluster of a Kubernetes cluster, the workload cluster comprising one or more control-plane (CP) nodes and one or more actual worker nodes, the one or more actual worker nodes comprising one or more interfaces with the one or more CP nodes, the one or more actual worker nodes being provided with a first number of physical computational resources; creating one or more mock nodes to replace the one or more actual worker nodes in the workload cluster, the one or more mock nodes configured with one or more mock interfaces that mimic the one or more interfaces of the one or more actual worker nodes, the one or more mock nodes configured with respective capacities to run application pods using the one or more mock interfaces; registering the one or more mock nodes as one or more actual worker nodes in a Kubernetes API server of the Kubernetes cluster based on the one or more mock interfaces; instantiating one or more network functions using the one or more mock nodes; and performing simulation of the one or more network functions using the one or more mock nodes by scheduling one or more application pods using the one or more mock interfaces to run on the one or more CP nodes of the workload cluster.

In some implementations, another example method includes: for the cluster, deploying a mock node for taking on a role of one or more actual worker nodes of the cluster, wherein: the mock node is provided with a first set of resources providing a first compute capacity; and the mock node includes an interface for interacting with an API server of the container orchestration system; configuring the interface to present to the container orchestration system an available compute capacity of a second compute capacity, the second compute capacity being greater than the first compute capacity; registering the mock node as an actual worker node of the cluster with the API server based on the interfaces of the mock nodes; causing the container orchestration system to deploy a plurality of application pods to the mock nodes, wherein the mock nodes does not instantiate the application pods; and obtaining events generated by the interface in the mock node indicating deployment and running statuses of the application pods.

Implementations of this and other disclosed methods can have any one or more of at least the following characteristics.

An aspect taken alone or combinable with any other aspect includes the following features. The computer-implemented method further includes releasing the first number of physical computational resources by deleting the actual worker nodes. Deleting the actual worker nodes includes deleting a configuration object (e.g., MachineDeployment CR) for a namespace of the workload cluster within a management cluster of the Kubernetes cluster.

An aspect taken alone or combinable with any other aspect includes the following features. The one or more mock nodes take a second number of physical computational resources that are less than the first number of physical computational resources.

An aspect taken alone or combinable with any other aspect includes the following features. Creating one or more mock nodes includes: specifying the respective capacities of the one or more mock nodes in a configuration object; and storing the configuration object on the one or more CP nodes of the workload cluster.

An aspect taken alone or combinable with any other aspect includes the following features. Scheduling one or more application pods using the one or more mock interfaces includes scheduling the one or more application pods using the one or more mock interfaces based on the respective capacities of the one or more mock nodes, wherein the respective capacities of the one or more mock nodes are larger than respective capacities of the one or more actual worker nodes supported by the first number of physical computational resources.

An aspect taken alone or combinable with any other aspect includes the following features. Scheduling one or more application pods using the one or more mock interfaces includes scheduling one or more application pods having volumes using the one or more mock interfaces.

An aspect taken alone or combinable with any other aspect includes the following features. The one or more mock interfaces includes one or more interfaces for creating an application pod having a volume, updating the application pod, deleting the application pod, obtaining the application pod, obtaining a status of the application pod, obtaining a plurality of application pods, or notifying the plurality of application pods.

An aspect taken alone or combinable with any other aspect includes the following features. Each of the one or more mock nodes includes an in-memory cache for storing application pod object information.

An aspect taken alone or combinable with any other aspect includes the following features. The Kubernetes cluster is one of a plurality of Kubernetes clusters deployed and managed by a telecommunication cloud automation platform (TCA), the TCA has an architecture comprising a layer of TCA-control plane (CP), a level of management clusters, and a layer of workload clusters. Performing simulation of the one or more network functions by scheduling one or more application pods using the one or more mock interfaces comprises scheduling a plurality of application pods having volumes on the one or more mock nodes to determine one or more limits of: a number of Kubernetes clusters deployed and managed by TCA, a number of worker nodes within Kubernetes clusters deployed and managed by TCA, a number of Kubernetes clusters deployed and managed by a given TCA-CP, a number of network functions deployed within a given Kubernetes cluster, a number of network functions deployed within a given TCA-CP, or a number of network functions deployed within the TCA.

An aspect taken alone or combinable with any other aspect includes the following features. The computer-implemented method further includes deploying the cluster of the container orchestration system that includes the one or more actual worker nodes, wherein the one or more actual worker nodes are provided with a third set of resources providing a third compute capacity, wherein the third set of resources are larger than the first set of resources of the mock node, and the third compute capacity is smaller than the second compute capacity.

An aspect taken alone or combinable with any other aspect includes the following features. The computer-implemented method further includes releasing the third set of resources by deleting the one or more actual worker nodes, wherein deleting the one or more actual worker nodes comprises deleting a configuration object for a namespace of the cluster of the container orchestration system.

An aspect taken alone or combinable with any other aspect includes the following features. Deploying the mock node includes creating one or more mock nodes by: specifying respective capacities of the one or more mock nodes in a configuration object; and storing the configuration object on one or more control-plane (CP) nodes of the cluster of the container orchestration system.

An aspect taken alone or combinable with any other aspect includes the following features. Causing the container orchestration system to deploy the plurality of application pods includes causing the container orchestration system to deploy the plurality of application pods having volumes using the interface.

An aspect taken alone or combinable with any other aspect includes the following features. The interface for interacting with the API server includes one or more interfaces for creating an application pod having a volume, updating the application pod, deleting the application pod, obtaining the application pod, obtaining a status of the application pod, obtaining a plurality of application pods, or notifying the plurality of application pods.

An aspect taken alone or combinable with any other aspect includes the following features. The computer-implemented method further includes performing simulation of a network function based on the events generated by the interface in the mock node indicating deployment and running statuses of the application pods.

An aspect taken alone or combinable with any other aspect includes the following features. The cluster of the container orchestration system includes a Kubernetes cluster that is one of a plurality of Kubernetes clusters deployed and managed by a telecommunication cloud automation (TCA) platform, the TCA platform has an architecture including a layer of a TCA-control plane (CP), a layer of management clusters, and a layer of workload clusters. Performing simulation of the network function includes determining one or more limits of: the number of Kubernetes clusters deployed and managed by the TCA platform, the number of worker nodes within the Kubernetes clusters deployed and managed by the TCA platform, the number of Kubernetes clusters deployed and managed by a given TCA-CP, the number of network functions deployed within a given Kubernetes cluster, the number of network functions deployed within the given TCA-CP, or the number of network functions deployed within the TCA platform.

Certain aspects of the subject matter described in this disclosure can be implemented as a non-transitory computer-readable medium storing instructions that, when executed by a hardware-based processor, perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other units suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory, or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASIC s (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a backend component, such as a data server that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship between client and server arises by virtue of computer programs running on the respective computers and having a client-server relationship with each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer implementable techniques. The bus system 650 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 600 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method for simulating a cluster of a container orchestration system, the method comprising:
for the cluster, deploying a mock node for taking on a role of one or more actual worker nodes of the cluster, wherein:
the mock node is provided with a first set of resources providing a first compute capacity; and
the mock node comprises an interface for interacting with an API server of the container orchestration system;
configuring the interface to present to the container orchestration system an available compute capacity of a second compute capacity, the second compute capacity being greater than the first compute capacity;
registering the mock node as an actual worker node of the cluster with the API server based on the interface of the mock node;
causing the container orchestration system to deploy a plurality of application pods to the mock node, wherein the mock node does not instantiate the application pods; and
obtaining events generated by the interface in the mock node indicating deployment and running statuses of the application pods.

2. The computer-implemented method of claim 1, wherein the computer-implemented method further comprises deploying the cluster of the container orchestration system that comprises the one or more actual worker nodes, wherein the one or more actual worker nodes are provided with a third set of resources providing a third compute capacity, wherein the third set of resources are larger than the first set of resources of the mock node, and the third compute capacity is smaller than the second compute capacity.

3. The computer-implemented method of claim 2, wherein the computer-implemented method further comprises releasing the third set of resources by deleting the one or more actual worker nodes,
wherein deleting the one or more actual worker nodes comprises deleting a configuration object for a namespace of the cluster of the container orchestration system.

4. The computer-implemented method of claim 1, wherein deploying the mock node comprises creating one or more mock nodes by:
specifying respective capacities of the one or more mock nodes in a configuration object; and
storing the configuration object on one or more control-plane (CP) nodes of the cluster of the container orchestration system.

5. The computer-implemented method of claim 1, wherein causing the container orchestration system to deploy the plurality of application pods comprises causing the container orchestration system to deploy the plurality of application pods having volumes using the interface.

6. The computer-implemented method of claim 1, wherein the interface for interacting with the API server comprises one or more interfaces for creating an application pod having a volume, updating the application pod, deleting the application pod, obtaining the application pod, obtaining a status of the application pod, obtaining a plurality of application pods, or notifying the plurality of application pods.

7. The computer-implemented method of claim 1, wherein the mock node comprises an in-memory cache for storing application pod object information.

8. The computer-implemented method of claim 1, wherein the computer-implemented method further comprises performing simulation of a network function based on the events generated by the interface in the mock node indicating deployment and running statuses of the application pods.

9. The computer-implemented method of claim 8, wherein the cluster of the container orchestration system comprises a Kubernetes cluster that is one of a plurality of Kubernetes clusters deployed and managed by a telecommunication cloud automation (TCA) platform, the TCA platform has an architecture comprising a layer of a TCA-control plane (CP), a layer of management clusters, and a layer of workload clusters, and
wherein performing simulation of the network function comprises determining one or more limits of:
the number of Kubernetes clusters deployed and managed by the TCA platform,
the number of worker nodes within the Kubernetes clusters deployed and managed by the TCA platform,
the number of Kubernetes clusters deployed and managed by a given TCA-CP,
the number of network functions deployed within a given Kubernetes cluster,
the number of network functions deployed within the given TCA-CP, or the number of network functions deployed within the TCA platform.

10. A non-transitory, computer-readable medium storing one or more instructions executable by a computer system to perform operations, the operations comprising:
for a cluster of a container orchestration system, deploying a mock node for taking on a role of one or more actual worker nodes of the cluster, wherein:
the mock node is provided with a first set of resources providing a first compute capacity; and
the mock node comprises an interface for interacting with an API server of the container orchestration system;
configuring the interface to present to the container orchestration system an available compute capacity of a second compute capacity, the second compute capacity being greater than the first compute capacity;
registering the mock node as an actual worker node of the cluster with the API server based on the interface of the mock node;
causing the container orchestration system to deploy a plurality of application pods to the mock node, wherein the mock node does not instantiate the application pods; and
obtaining events generated by the interface in the mock node indicating deployment and running statuses of the application pods.

11. The non-transitory, computer-readable medium of claim 10, the operations further comprising deploying the cluster of the container orchestration system that comprises the one or more actual worker nodes, wherein the one or more actual worker nodes are provided with a third set of resources providing a third compute capacity, wherein the third set of resources are larger than the first set of resources of the mock node, and the third compute capacity is smaller than the second compute capacity.

12. The non-transitory, computer-readable medium of claim 11, the operations further comprising releasing the third set of resources by deleting the one or more actual worker nodes,
wherein deleting the one or more actual worker nodes comprises deleting a configuration object for a namespace of the cluster of the container orchestration system.

13. The non-transitory, computer-readable medium of claim 10, wherein deploying the mock node comprises creating one or more mock nodes by:
specifying respective capacities of the one or more mock nodes in a configuration object; and
storing the configuration object on one or more control-plane (CP) nodes of the cluster of the container orchestration system.

14. The non-transitory, computer-readable medium of claim 10, wherein causing the container orchestration system to deploy the plurality of application pods comprises causing the container orchestration system to deploy the plurality of application pods having volumes using the interface.

15. The non-transitory, computer-readable medium of claim 10, wherein the interface for interacting with the API server comprises one or more interfaces for creating an application pod having a volume, updating the application pod, deleting the application pod, obtaining the application pod, obtaining a status of the application pod, obtaining a plurality of application pods, or notifying the plurality of application pods.

16. The non-transitory, computer-readable medium of claim 10, wherein the mock node comprises an in-memory cache for storing application pod object information.

17. The non-transitory, computer-readable medium of claim 10, the operations further comprises performing simulation of a network function based on the events generated by the interface in the mock node indicating deployment and running statuses of the application pods.

18. The non-transitory, computer-readable medium of claim 17, wherein the cluster of the container orchestration system comprises a Kubernetes cluster that is one of a plurality of Kubernetes clusters deployed and managed by a telecommunication cloud automation (TCA) platform, the TCA platform has an architecture comprising a layer of a TCA-control plane (CP), a layer of management clusters, and a layer of workload clusters, and
wherein performing simulation of the network function comprises determining one or more limits of:
the number of Kubernetes clusters deployed and managed by TCA,
the number of worker nodes within Kubernetes clusters deployed and managed by TCA,
the number of Kubernetes clusters deployed and managed by a given TCA-CP,
the number of network functions deployed within a given Kubernetes cluster,
the number of network functions deployed within the given TCA-CP, or
the number of network functions deployed within the TCA.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, the one or more operations comprising:
for a cluster of a container orchestration system, deploying a mock node for taking on a role of one or more actual worker nodes of the cluster, wherein:
the mock node is provided with a first set of resources providing a first compute capacity; and
the mock node comprises an interface for interacting with an API server of the container orchestration system;
configuring the interface to present to the container orchestration system an available compute capacity of a second compute capacity, the second compute capacity being greater than the first compute capacity;
registering the mock node as an actual worker node of the cluster with the API server based on the interface of the mock node;
causing the container orchestration system to deploy a plurality of application pods to the mock node, wherein the mock node does not instantiate the application pods; and
obtaining events generated by the interface in the mock node indicating deployment and running statuses of the application pods.

20. The computer-implemented system of claim 19, wherein deploying the mock node comprises creating one or more mock nodes by:
specifying respective capacities of the one or more mock nodes in a configuration object; and
storing the configuration object on one or more control-plane (CP) nodes of the cluster of the container orchestration system.
